(19) United States
(12) Patent Application Publication
(10) Pub. No.: US 2013/0111029 A1
(43) Pub. Date: May 2, 2013

(54) Travel star online web portal application

(71) Applicant: Michael Campbell, Torrance, CA (US)

(72) Inventor: Michael Campbell, Torrance, CA (US)

(21) Appl. No.: 13/317,840

(22) Filed: Oct. 31, 2011

(51) Int. Cl. G06F 15/173

(52) U.S. Cl. 709/225

(57) ABSTRACT

Travel Star Online Web Portal Application is a new concept through design and functionality that allows any mobile or PC user by I Phone, internet connection or any other mobile or PC device without any specific software to gain access to the portal and find existing applications for the user to access through the portal instead of searching the internet for one specific application.

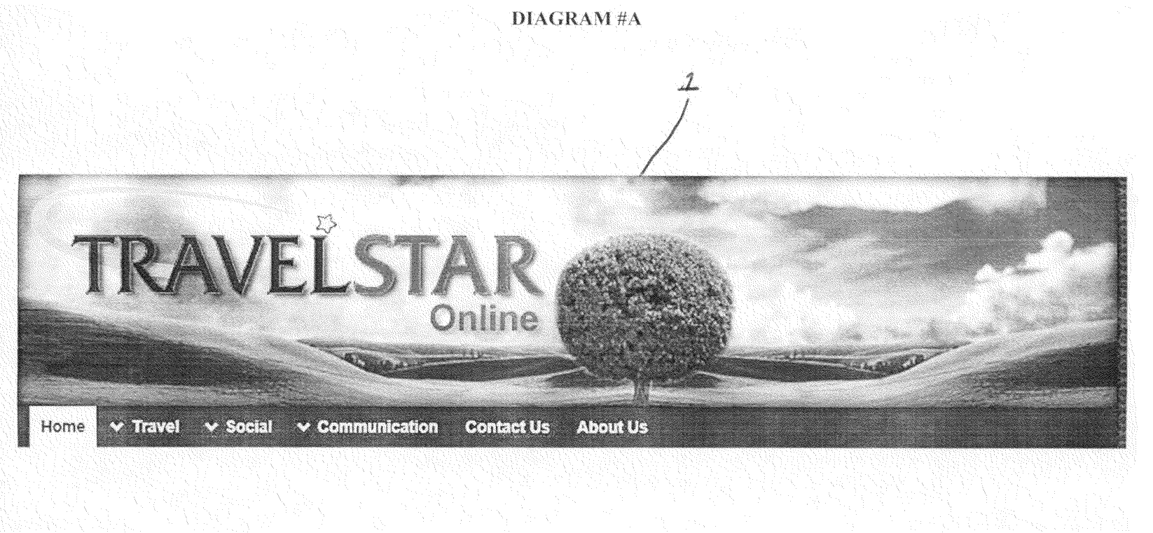

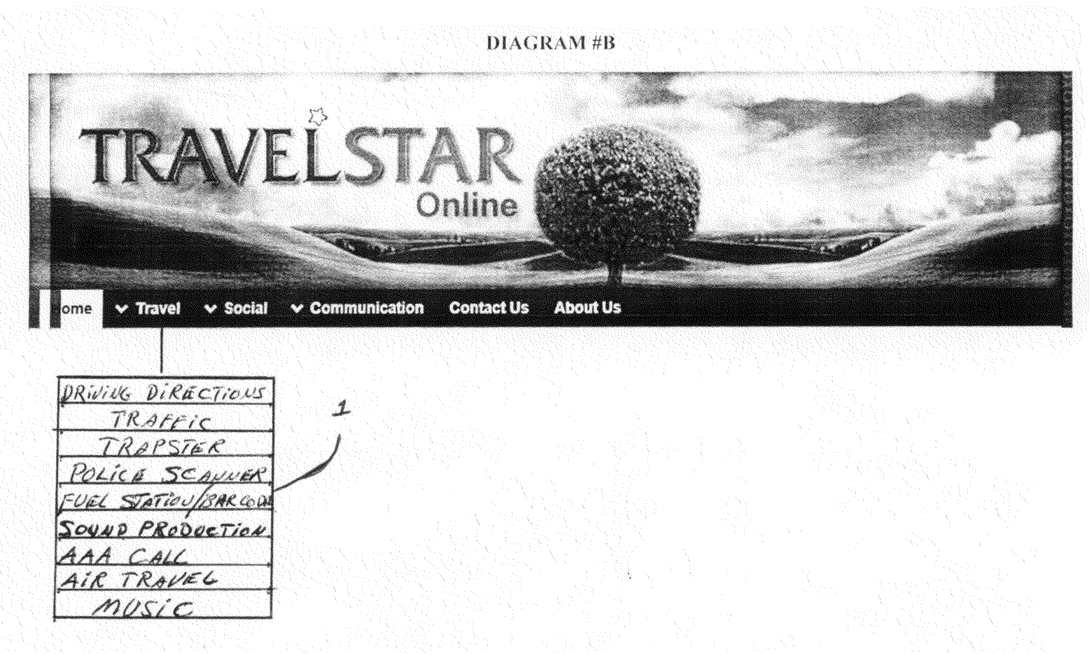

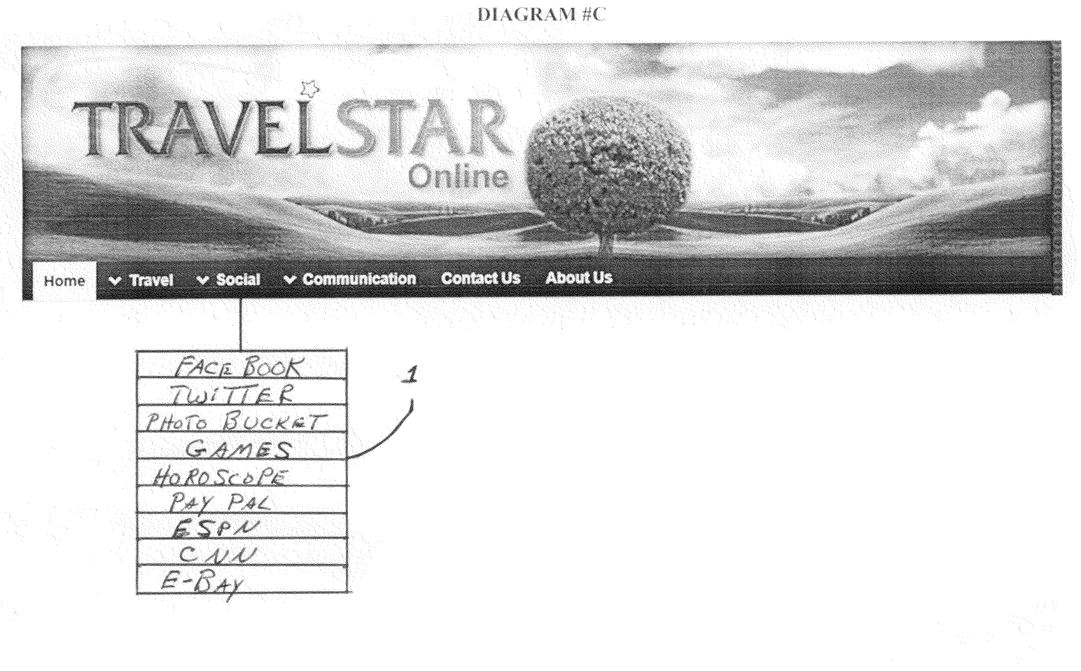

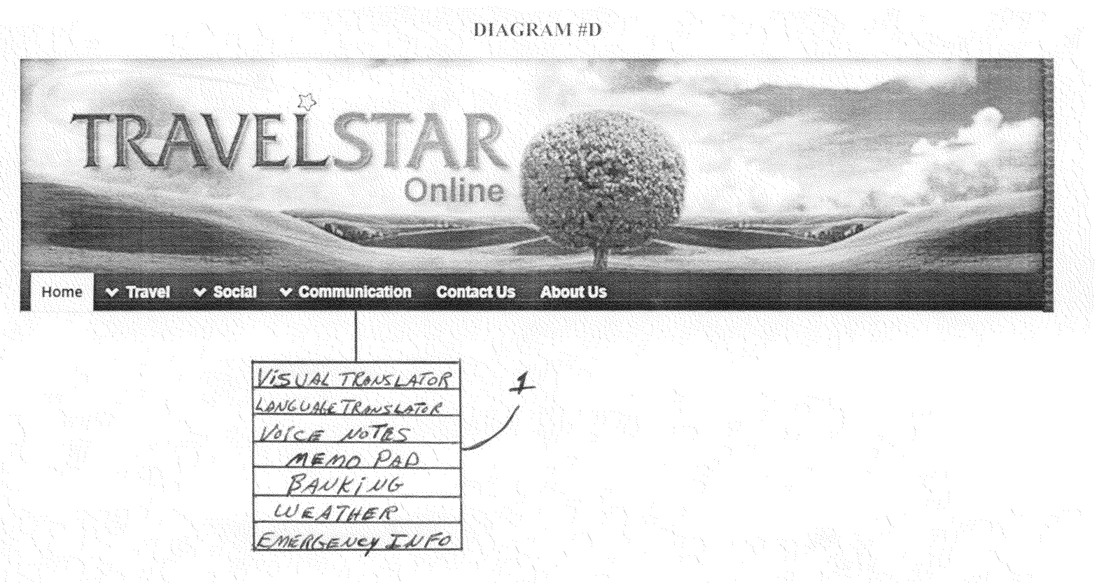

### BACKGROUND OF THE INVENTION

(1) Field of the Invention

The invention is within the web based world that now exists using the website as a portal to introduce many different companies and or applications for use in a mobile environment. Opposed to one application by each individual company a web based portal can perform many different functions using existing companies and their applications for sale and distribution through the portal offering a one stop application for mobile use by the user.

(2) Description of the Art Including Information Disclosed Under 37 CFR 1.97 & 1.98

The art described in the drawings of the design and utility show that the website is designed as a portal to easily find what application a user may be looking for and allowing an instant connection to that application or service or product the user is looking for.

### BRIEF SUMMARY OF THE INVENTION

The Travel Star Online Web Portal Application is a new concept through design and functionality that allows any mobile or PC user by I Phone, internet connection or any other mobile or PC device without any specific software to gain access to the portal and find existing applications for the user to access through the portal instead of searching the Internet for one specific application.

### BRIEF DESCRIPTION OF THE SEVERAL VIEWS OF THE DRAWINGS

There are 4 drawings in total that describe and illustrate the design and function of the “Travel Star Online Web Portal Application”.

Diagram A:

Illustrations 1:

#1 illustrates the main banner with the trademark name and design. It also illustrates the six website titles as: Home-Travel-Social-Communication-Contact Us-About us

Diagram B:

Illustrations 1:

#1 illustrates the Travel drop down box containing the nine or more applications that move to an interactive page that Travel Star Online operates or moves to the company website of the application. The applications indicated are: Driving Directions-Traffic-Trapster-Police Scanner-Fuel Station/Bar Code-Sound Production-AAA call-Air Travel-Music.

Diagram C:

Illustrations 1:

#1 illustrates the Social drop down box containing nine or more applications that move to an interactive page that Travel Star Online operates or moves to the company website of the application. The applications indicated are: Facebook-Twitter-Photo Bucket-Games-Horoscope-Pay Pal-ESPN-CNN-E-Bay.

Diagram D:

Illustrations 1:

#1 illustrates the Communication drop down box containing seven or more applications that move to an interactive page that Travel Star Online operates or moves to the company website of the application. The applications indicated are: Visual Translator-Language Translator-Voice Notes-Memo Pad-Banking-Weather-Emergency Info.

### DETAILED DESCRIPTION OF THE INVENTION

The Travel Star Web Portal Application is a web based portal that offers fast and easy access to any existing application relevant to the travel, social, and communication world. For Travel it offers driving directions, traffic reports, scanners, fuel station locations and bar coding pricing, AAA call, air travel information and prices and scheduling. For Social it offers Facebook interface, Twitter interface, You Tube interface, ESPN sports information, CNN access, E-Bay interface, and more. For communication it offers Audio sound boards for automobile sounds for electric cars and other vehicles for fast and easy downloads to indicate the vehicles presence, alarm sounds, music, visual translator, language translator, banking, weather, emergency information and access, games, horoscope and much more.

1: A web based portal using proprietary or non-proprietary existing applications for the use of mobile or PC users to quickly and easily access information and use of the application within one specific portal opposed to searching the internet for one particular application, service or product without the use of an apparatus or proprietary software or application by using the existing application in all of its design and functionality that is both proprietary and non-proprietary which is wholly owned by another company or by Travel Star Online.

2: A portal in which the design and functionality are proprietary to Travel Star Online alone and not using any existing software application by any other company and allowing the use of the application(s) by any other company to achieve the desired result from the user through the company site application or interactive application licensed by the company to Travel Star Online or is wholly owned by Travel Star Online.

3: The use of the portal by any user that will use the fast and easy access to any existing application through their own PC, I phone, or any other device the user wishes to use and pay or not pay a small fee to use the application for any other application, service, product, or for any use that suits the user through the portals proprietary design and functionality.
